(19) United States
(12) Patent Application Publication
(10) Pub. No.: US 2026/0063155 A1
(43) Pub. Date: Mar. 5, 2026

(54) CLIP ASSEMBLIES, SYSTEMS, AND METHODS FOR OPERATING DISPLACEMENT TOOLS

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/311,342

(22) Filed: Aug. 27, 2025

Related U.S. Application Data
(60) Provisional application No. 63/690,672, filed on Sep. 4, 2024.

(51) Int. Cl. F16B 2/24

(52) U.S. Cl. CPC F16B 2/245

(57) ABSTRACT

A clip assembly for a displacement system used to displace a rod member from a structural member. The clip assembly comprises a clip body defining a clip channel and at least one detent assembly comprising a detent member and a resilient member. The detent member is supported for movement between an extended position and a retracted position relative to the clip body, and the resilient member configured to bias the detent member from the retracted position towards the extended position. The clip channel is configured to receive at least a portion of the rod member such that, when the detent member is in the extended position, the detent member engages the at least a portion of the rod member to detachably attach the clip body in a desired position relative to the rod member.

### RELATED APPLICATIONS

This application (Attorney's Ref. No. P220697) claims benefit of U.S. Provisional Application Ser. No. 63/690,672 filed Sep. 4, 2024, the contents of which are incorporated herein by reference.

### TECHNICAL FIELD

The present invention relates to accessories for displacement tools and, in particular, to a clip assembly that can decrease the time required to use a displacement tool to perform a particular task.

### SUMMARY

The present invention may be embodied as a clip assembly for a displacement system used to displace a rod member from a structural member. The clip assembly comprises a clip body defining a clip channel and at least one detent assembly comprising a detent member and a resilient member. The detent member is supported for movement between an extended position and a retracted position relative to the clip body, and the resilient member configured to bias the detent member from the retracted position towards the extended position. The clip channel is configured to receive at least a portion of the rod member such that, when the detent member is in the extended position, the detent member engages the at least a portion of the rod member to detachably attach the clip body in a desired position relative to the rod member.

The present invention may also be embodied as a method for displacing a rod member relative to a structural member with a displacement system, comprising the following steps. A clip body defining a clip channel and at least one detent assembly are provided. The detent assembly comprises a detent member supported for movement between an extended position and a retracted position relative to the clip body and a resilient member configured to bias the detent member from the retracted position towards the extended position. The clip channel is configured to receive at least a portion of the rod member such that, when the detent member is in the extended position, the detent member engages the at least a portion of the rod member to detachably attach the clip body in a desired position relative to the rod member.

The present invention may also be embodied as a clip assembly for a displacement system used to displace a rod member from a structural member. The clip assembly comprises a clip body and at least one detent assembly. The clip body defines a clip channel and at least one detent cavity. The at least one detent assembly comprising a detent member and a resilient member. The resilient member is configured to be arranged in the detent cavity such that the resilient member engages at least a portion of the detent member such that the detent member may be moved between an extended position and a retracted position. The clip channel is configured to receive at least a portion of the rod member. The resilient member biases the detent member into the extended position such that the detent member may engage the detachably attach the clip body to the rod member.

### BRIEF DESCRIPTION OF THE DRAWINGS

FIG. 1 is a perspective view of a first example clip assembly of the present invention;

FIG. 2 is a top plan view illustrating a first step in a process of using the first example clip assembly;

FIG. 2A is a top plan view of a second example clip assembly of the present invention;

FIG. 3 is a top plan view illustrating a second step in the process of using the first example clip assembly;

FIG. 4 is a perspective view of a first example pull rod assembly that may be used with any of the clip assemblies described herein;

FIG. 5 illustrates a rod assembly and a structural member from which the bolt assembly is to be displaced;

FIG. 6 illustrates a step of connecting the first example pull rod assembly to rod member of the bolt assembly depicted in FIG. 5;

FIG. 7 illustrates a step of arranging a bearing sleeve over a portion of the pull rod assembly connected to the rod member;

FIG. 8 illustrates a step of arranging a displacement system over a portion of the pull rod assembly and in contact with the bearing sleeve;

FIG. 9 illustrates a step of operating the displacement system to displace the pull rod assembly and rod member a first distance relative to the structural member;

FIGS. 10 and 11 illustrate a step of arranging either the first example clip assembly or the second example clip assembly on a first exposed portion of a pull rod of the pull rod assembly;

FIG. 12 illustrates the step of operating the displacement system to displace the pull rod assembly and rod member a second distance relative to the structural member;

FIG. 13 illustrate a step of arranging either the first example clip assembly or the second example clip assembly on a second exposed portion of a pull rod of the pull rod assembly;

FIG. 14 illustrates the step of operating the displacement system to displace the pull rod assembly and rod member a third distance relative to the structural member;

FIG. 15 illustrates the step of displacing the rod member, the pull rod assembly, the first or second example clip assemblies on the first and second exposed portions of the pull rod, and the displacement system away from the structural member, at which the point the rod member has been removed from the structural member;

FIG. 16 illustrates a member to be removed from a structural member;

FIGS. 17 and 18 illustrate a step of arranging either the first example clip assembly or the second example clip assembly on a first exposed portion of a push rod member and either the first example clip assembly or the second example clip assembly on a second exposed portion of the push rod member;

FIG. 19 illustrates the step of displacing the push rod assembly, the first or second example clip assemblies on the first and second exposed portions of the push member, and the displacement system toward the structural member so the push member engages the member and displaces the member relative to the structural member;

FIG. 20 illustrates the step of displacing the rod member, the push rod assembly, the first or second example clip assemblies on the first and second exposed portions of the push member, and the displacement system away from the structural member;

FIG. 21 illustrates the step of arranging either the first example clip assembly or the second example clip assembly on a third exposed portion of the push rod member; and

FIG. 22 illustrates the step of displacing the push rod assembly, the first or second example clip assemblies on the first, second, and third exposed portions of the push member, and the displacement system toward the structural member, at which point the member has been removed from the structural member.

### DETAILED DESCRIPTION

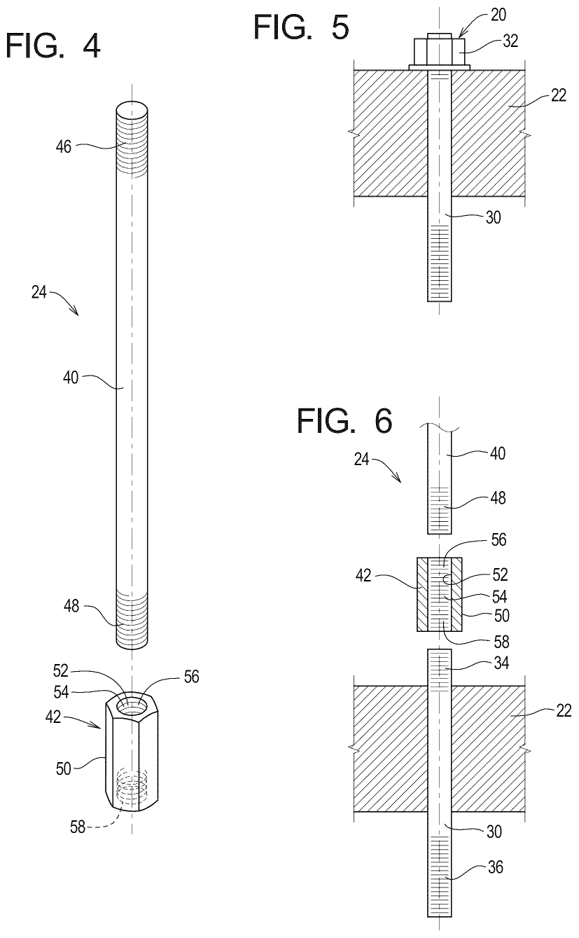

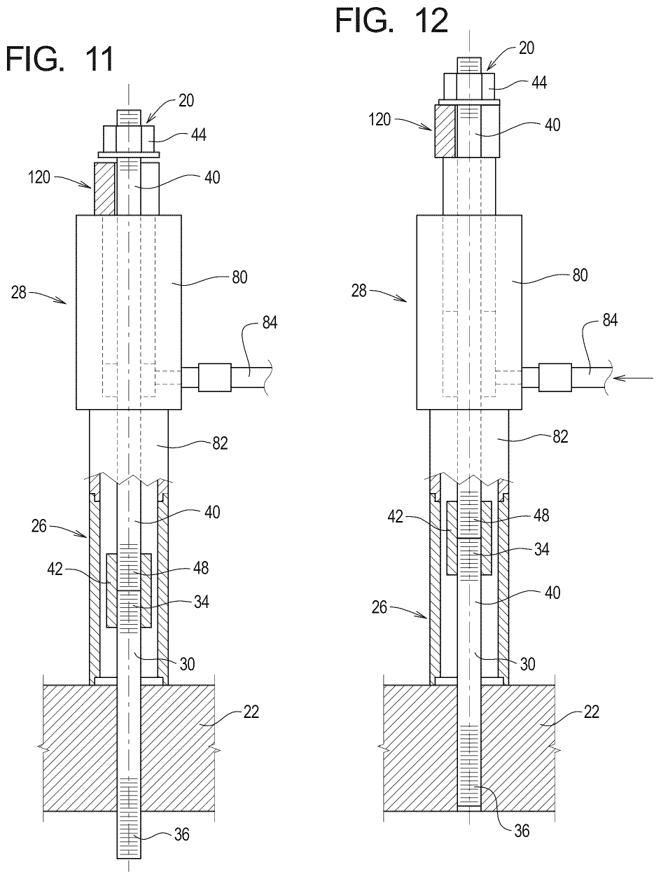

Referring initially to FIGS. 4-15 of the drawing, depicted therein is a rod assembly 20 connected to or embedded within a structural member 22. The rod assembly comprises a rod member 30 and a rod nut 32. The example rod member 30 has first and second rod member threaded ends 34 and 36. The systems and methods of the present invention are used to remove the rod member 30 from the structural member 22.

FIGS. 4-15 further illustrate a pull rod assembly 24, a transfer sleeve 26, and a displacement system 28. The pull rod assembly 24 comprises a pull rod 40, a pull collar 42, and a pull nut 44. The pull rod 40 defines first and second pull rod threaded ends 46 and 48. The example pull collar 42 defines a collar side surface 50 and a collar interior surface 52 defining a collar passageway 54. First and second collar threaded portions 56 and 58 are formed on the collar interior surface 52. The example transfer sleeve 26 defines first and second sleeve bearing surfaces 60 and 62, a sleeve side surface 64, and a sleeve interior surface 66 defining a sleeve passageway 68. First and second sleeve bearing notches 70 and 72 are formed on the first and second sleeve bearing surfaces 60 and 62, respectively. The example displacement system 28 comprises housing assembly 80 and a piston member 82 and connected to a fluid source 84. Introducing pressurized fluid into the housing assembly 80 displaces the piston member 82 a drive distance 86 relative to the housing assembly 80.

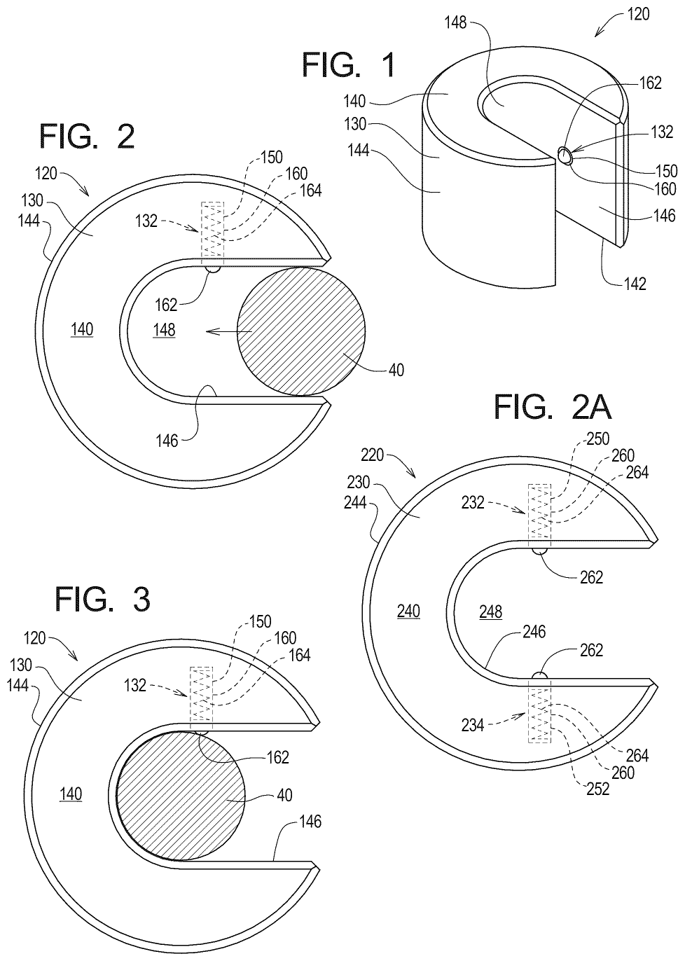

The present invention comprises one or more first example clip assemblies 120 as shown in FIGS. 1-3. The clip assembly 120 or clip assemblies 120 are configured to be detachably attached to the pull rod 40 to take up slack in the displacement system 28 without having to move (i.e., rotate) the pull nut 44 attached to the pull rod 40 during operation of the displacement system 28. Using the clip assembly 120 rather than rotating the pull nut 44 saves significant time when removing the rod member 30 from the structural member 22 using the pull rod assembly 24, transfer sleeve 26, and displacement system 28.

The first example clip assembly 120 comprises a clip body 130 and a detent assembly 132. The clip body 130 defines a first clip bearing surface 140 and a second clip bearing surface 142, a side surface 144, and an interior surface 146 defining a clip channel 148. A detent cavity 150 is formed in the interior surface 146. The example detent assembly 132 comprises a detent barrel 160, a detent member 162, and a resilient member 164. The resilient member 164 biases a portion of the detent member 162 out of the detent barrel 160 in an extended position, but the detent member 162 can be forced into a retracted position relative to the detent barrel 160 against the force of the resilient member 164 by deliberate application of manual force.

The detent assembly 132 is arranged partly within the detent cavity 150 such that the detent member 162 in the extended position is within the clip channel 148.

The clip channel 148 is sized and dimensioned to receive the pull rod 40 as shown in FIGS. 2 and 3. In particular, the clip assembly 120 can be displaced such that the pull rod 40 enters the clip channel 148. The detent cavity 150 is arranged within the clip channel 148 such that, as the pull rod 40 engages the detent member 162, the detent member 162 is forced into the retracted position, allowing the pull rod 40 to be displaced past the detent member 162 and into a secured position at an interior end of the clip channel 148 as shown in FIG. 3. At this point, the resilient member 164 forces the detent member 162 out of the detent barrel 160 to inhibit movement of the clip assembly 120 relative to the pull rod 60.

The clip assembly 120 can easily be removed by displacing the clip body 130 away from the pull rod 40. When the pull rod 40 engages the detent member 162, the pull rod 40 again forces the detent member 160 from the extended position to the retraced position to allow the pull rod 40 to exit the clip channel 148, thereby allowing the clip assembly 120 to be removed from the pull rod by deliberate application of manual force.

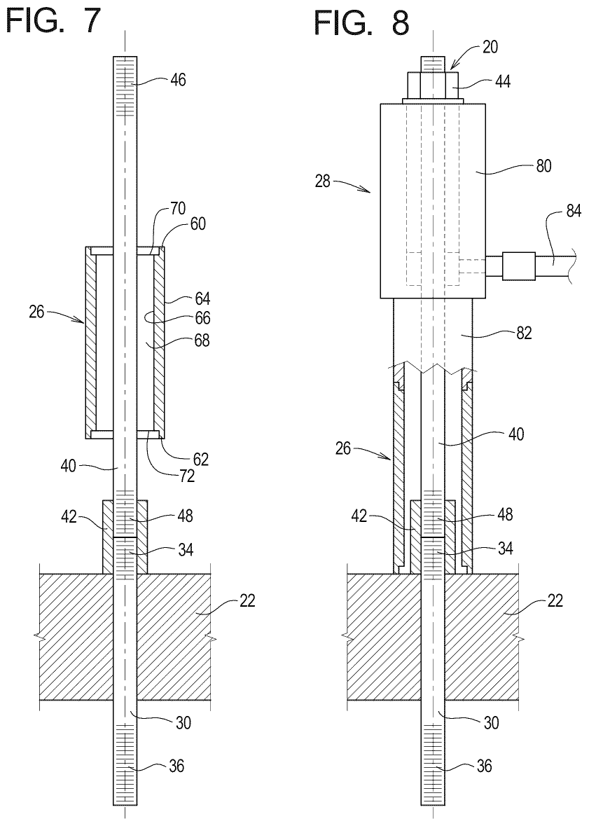

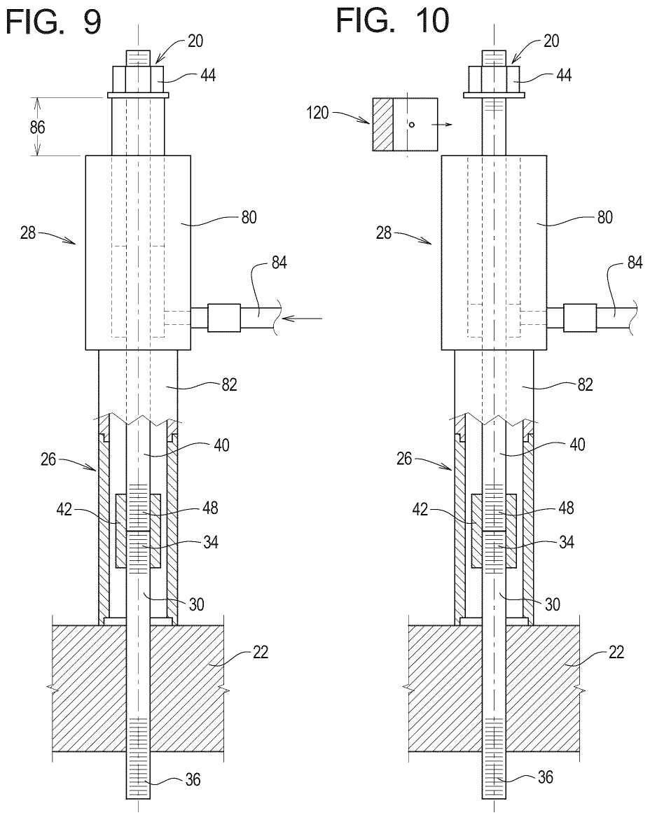

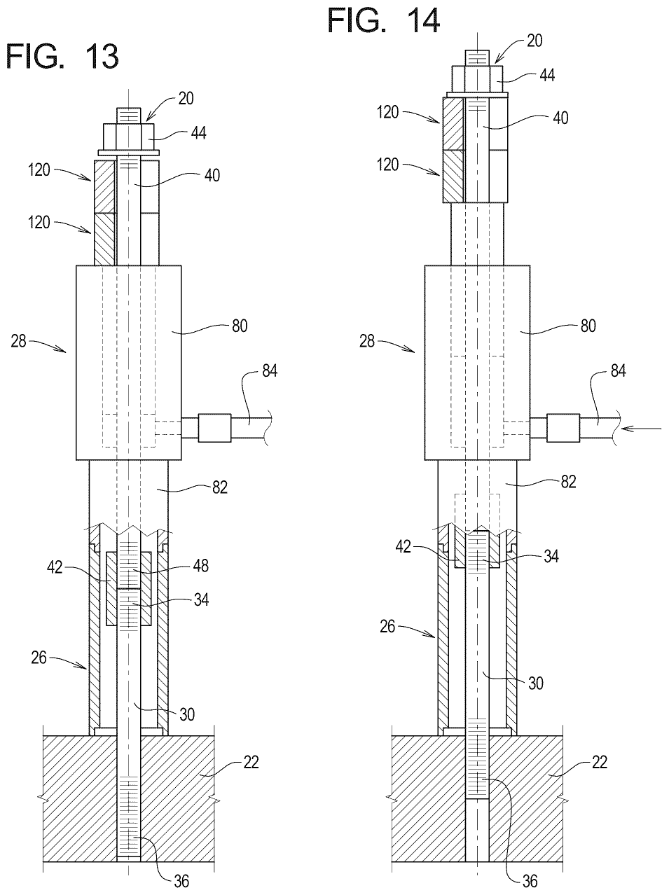

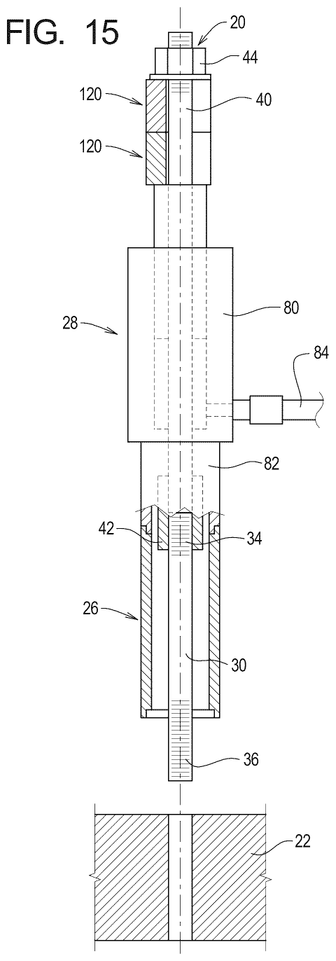

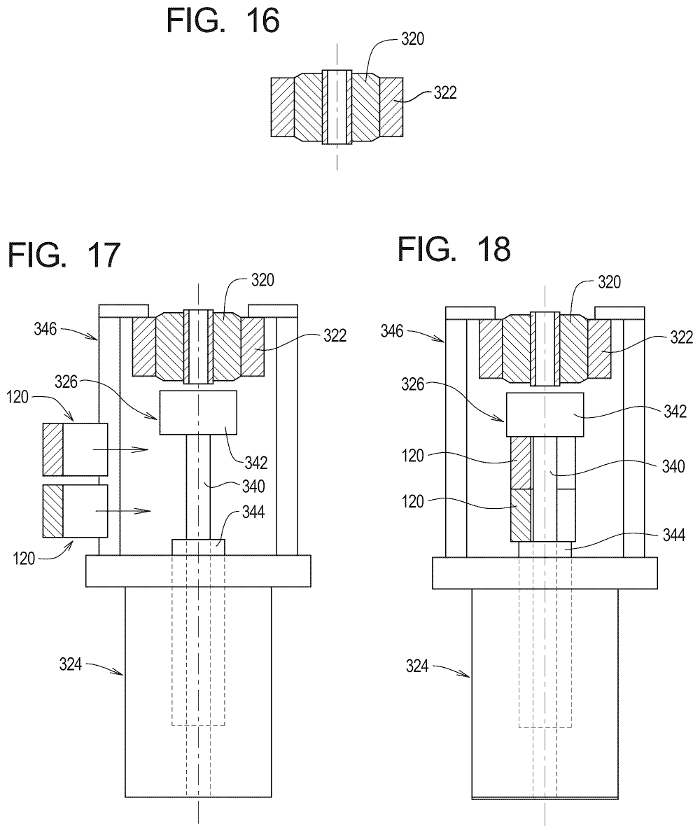

As shown in FIGS. 4-15, the rod nut 32 is removed from the rod member 30 as shown in FIG. 6, and the pull collar 42 is threaded onto the rod member 30 and the pull rod 40 as shown in FIG. 7. The transfer sleeve 26 is then arranged over a portion of the pull rod assembly 24 until the transfer sleeve 26 engages the structural member 22 as shown in FIG. 8. The displacement system 28 is arranged over the pull rod assembly 24 until the housing 80 engages the transfer sleeve 26. At this point the pull nut 44 is threaded onto the pull rod 40. Operation of the displacement system as shown in FIGS. 8 and 9 displaces the rod member 30 a first distance relative to the structural member 22. As shown in FIGS. 10-12, a first clip assembly 120 is then arranged on a first exposed portion of the pull rod 40 between the pull nut 44 and the housing 80, and the displacement system 28 is operated again to displace the rod member 30 a second distance relative to the structural member 22. Next, as shown in FIGS. 13-14, a second clip assembly 120 is then arranged on a second exposed portion of the pull rod 40 between the pull nut 44 and the housing 80, and the displacement system 28 is operated again to displace the rod member 30 a third distance relative to the structural member 22. At this point, the rod member 30 is removed from the structural member 22 as shown in FIG. 15.

FIG. 2A of the drawing depicts a second example clip assembly 220 constructed in accordance with, and embodying, the principles of the present invention. The second example clip assembly 220 comprises a clip body 230 and first and second detent assembly 232 and 234. The clip body 230 defines a second clip bearing surface 240 and a second clip bearing surface (not visible), a side surface 244, and an interior surface 246 defining a clip channel 248. First and second detent cavities 250 and 252 formed in the interior surface 246. The example detent assemblies 232 and 234 comprises a detent barrel 260, a detent member 262, and a resilient member 264. The resilient member 264 biases a portion of the detent member 262 out of the detent barrel 260 in an extended position, but the detent member 262 can be forced into a retracted position relative to the detent barrel 260 against the force of the resilient member 264 by deliberate application of manual force.

The second example clip assembly 220 may be used in essentially the same manner as the first example clip assembly 120 described above, except that additional grip on the pull rod 40 is provided by the first and second detent assemblies 232 and 234.

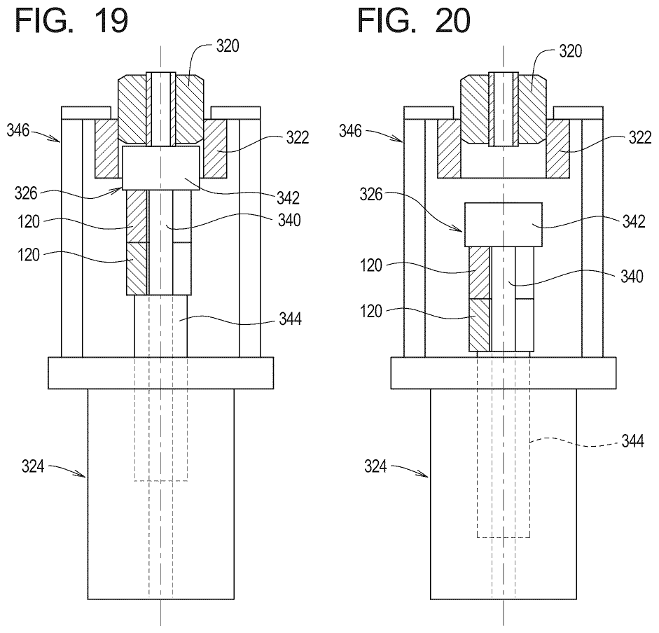

Referring to FIGS. 17-22, depicted therein is the use of the clip assemblies 120 and/or 220 to push a member 320 out of a structural member 322 using a displacement system 324 comprising a push rod assembly 326. The push rod assembly 326 comprises a push rod member 340, a push member 342, a push sleeve 344, and a push housing 346. The following discussion refers to using the first example clip assembly 120 to push the member 320 out of the structural member 322, however, either the first example clip assembly 120 or the second example clip assembly 220 can be used.

As shown in FIGS. 17-20, the push housing 346 is arranged to engage the structural member 322. The push rod member 340 is positioned so that it exposes a first exposed portion and a second exposed portion. The clip assemblies 120 can be placed on the first exposed portion and second exposed portion, respectively. The displacement system 324 is operated until the push member 342 engages the member 320. As the displacement system 324 is operated the member 320 is displaced a first push distance relative to the structural member 322.

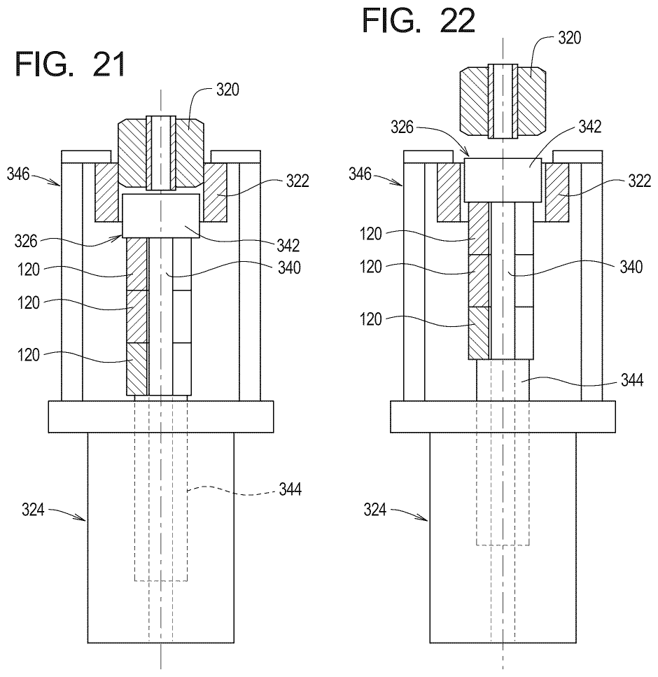

As shown in FIGS. 21-22, once the push rod member 340 has been displaced the first push distance, a third exposed portion of the push rod member 340 is exposed. An additional clip assembly 120 can be placed on the third exposed portion of the push rod member 340. The displacement system is then operated until the push member 342 engages the member 320 and displaces the push rod assembly 326 and the clip assemblies 120 toward the member 320 until the member 320 is completely displaced from the structural member 322.

What is claimed is:

1. A clip assembly for a displacement system used to displace a rod member from a structural member, the clip assembly comprising:
a clip body defining a clip channel;
at least one detent assembly comprising
a detent member supported for movement between an extended position and a retracted position relative to the clip body, and
a resilient member configured to bias the detent member from the retracted position towards the extended position; wherein
the clip channel is configured to receive at least a portion of the rod member such that, when the detent member is in the extended position, the detent member engages the at least a portion of the rod member to detachably attach the clip body in a desired position relative to the rod member.

2. The clip assembly as recited in claim 1, in which the detent assembly is configured to engage the rod member to allow the rod member to rotate.

3. The clip assembly as recited in claim 1, in which the clip body comprises a detent cavity configured to support the detent assembly.

4. The clip assembly as recited in claim 3, in which
the resilient member is arranged in the detent cavity;
the resilient member is configured to engage the detent member such that
when deformed, the resilient member allows the detent member to be positioned at least partly in the detent cavity when the detent member is in the retracted position, and
when undeformed, the resilient member allows the detent member to be positioned at least partly in the clip channel when the detent member is in the extended position.

5. The clip assembly as recited in claim 1, comprising a first detent assembly and a second detent assembly.

6. The clip assembly as recited in claim 5, in which:
a first detent member of the first detent assembly is configured to engage a first portion of the rod member; and
a second detent member of the second detent assembly is configured to engage a second portion of the rod member.

7. The clip assembly as recited in claim 1, in which the clip body is configured to allow the rod member to be displaced a predetermined distance.

8. A method for displacing a rod member relative to a structural member with a displacement system, comprising the steps of:
providing a clip body defining a clip channel;
providing at least one detent assembly comprising
a detent member supported for movement between an extended position and a retracted position relative to the clip body, and
a resilient member configured to bias the detent member from the retracted position towards the extended position;
configuring the clip channel to receive at least a portion of the rod member such that, when the detent member is in the extended position, the detent member engages the at least a portion of the rod member to detachably attach the clip body in a desired position relative to the rod member.

9. The method as recited in claim 8, further comprising configuring the detent assembly to engage the rod member to allow the rod member to rotate.

10. The method as recited in claim 8, in which the step of providing a clip body comprises providing a detent cavity configured to support the detent assembly.

11. The method as recited in claim 10, further comprising:
arranging the resilient member in the detent cavity;
configuring the resilient member to engage the detent member such that
when deformed, the resilient member allows the detent member to be positioned at least partly in the detent cavity, and
when undeformed, the resilient member allows the detent member to be positioned at least partly in the clip channel when the detent member is in the extended position.

12. The method as recited in claim 8, further comprising providing a first detent assembly and a second detent assembly.

13. The method as recited in claim 12, further comprising
configuring a first detent member of the first detent assembly to engage a first portion of the rod member; and
configuring a second detent member of the second detent assembly to engage a second portion of the rod member.

14. The method as recited in claim 8, further comprising configuring the clip body to allow the rod member to be displaced a predetermined distance.

15. A clip assembly for a displacement system used to displace a rod member from a structural member, the clip assembly comprising:
a clip body defining a clip channel and at least one detent cavity;
at least one detent assembly comprising a detent member and a resilient member; wherein
the resilient member is configured to be arranged in the detent cavity such that the resilient member engages at least a portion of the detent member such that the detent member may be moved between an extended position and a retracted position;
the clip channel is configured to receive at least a portion of the rod member; and
the resilient member biases the detent member into the extended position such that the detent member may engage the detachably attach the clip body to the rod member.

16. The clip assembly as recited in claim 15, in which the detent assembly is configured to engage the rod member to allow the rod member to rotate.

17. The clip assembly as recited in claim 15, in which
the resilient member is configured to engage the detent member such that, with the detent member in the extended position, the detent member is positioned at least partly in the detent cavity and at least partly in the clip channel to inhibit movement of the rod out of the clip channel; and
the resilient member is configured to engage the detent member such that, with the detent member in the retracted position, the detent member allows movement of the rod into and out of the clip channel.

18. The clip assembly as recited in claim 15, comprising a first detent assembly and a second detent assembly.

19. The clip assembly as recited in claim 18, in which, with the rod arranged within the clip channel, a first detent member of the first detent assembly is configured to engage a first portion of the rod member and a second detent member of the second detent assembly is configured to engage a second portion of the rod member to inhibit movement of the rod out of the clip channel.
